(19) United States
(12) Patent Application Publication
(10) Pub. No.: US 2008/0078092 A1
(43) Pub. Date: Apr. 3, 2008

(54) Protractor for teaching aid

(75) Inventor: Wen-Yuan Lin, Taipei County (TW)

Correspondence Address: LIN, WEN-YUAN, 20525 Via Talavera, Yorba Linda, CA, 92887, US

(73) Assignee: YOUTH TOY ENTERPRISE CO., LTD.

(21) Appl. No.: 11/541,614

(22) Filed: Oct. 3, 2006

(51) Int. Cl. B43L 7/10

(52) U.S. Cl. 33/471

(57) ABSTRACT

A protractor for teaching aid includes a semicircular disk being provided along a curved section with angle marks and along a straight edge with length marks to form a main body of the protractor, and at a center with a locating hole or a locating bar; and at least one indicating strip being provided at two ends at one side with a short bar each, with a receiving hole correspondingly formed behind each short bar, and on one surface along a centerline with a central marker. The indicating strips may be rotatably connected at the short bars or the receiving holes to the locating hole or the locating bar, respectively, or rotatably connected end to end to form a polygon, so that the protractor has not only the function of measuring an angle, but also many other teaching functions.

### FIELD OF THE INVENTION

The present invention relates to a protractor for teaching aid, and more particularly to a protractor has not only the function of measuring an angle and a distance, but also many other teaching functions.

### BACKGROUND OF THE INVENTION

A conventional protractor for teaching aid in early stage has a relatively simple structure including a semicircular disk having angle marks provided along a curved section for measuring a specific angle, and length marks along a straight edge for measuring a specific distance. There is not any other auxiliary means provided on the protractor for teaching purpose. Later, a conventional protractor for teaching aid with a handle is developed, enabling the protractor to be more conveniently manipulated. However, the conventional protractors with or without a handle all have simple functions of measuring an angle or a distance without any other additional function. Therefore, the conventional protractors for teaching aid have limited usage and do not meet the consumers' requirements. It is therefore tried by the inventor to develop a protractor for teaching aid that has not only the function of measuring an angle and a distance, but also many other teaching functions to overcome the shortage of the conventional protractors for teaching aid.

### SUMMARY OF THE INVENTION

A primary object of the present invention is to provide a protractor for teaching aid that includes mechanism to enable angle measuring in a more convenient manner.

Another object of the present invention is to provide a protractor for teaching aid that has not only the function of measuring an angle and a distance, but also the function of demonstrating different polygons in teaching.

To achieve the above and other objects, the protractor for teaching aid according to the present invention includes a semicircular disk being provided along a curved section with angle marks and along a straight edge with length marks to form a main body of the protractor, and at a center with a locating section; and at least one indicating strip being provided at two ends at one side with a short bar each, with a receiving hole correspondingly formed behind each short bar, and on one surface along a centerline with a central marker. The indicating strips may be rotatably connected at the short bars or the receiving holes to the locating section on the semicircular disk. And, the central marker on the indicating strip allows easy and accurate read of an angle mark representing an angle being measured.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a protractor for teaching aid according to a first embodiment of the present invention;

FIG. 2 is an assembled view of FIG. 1;

FIG. 3 is a sectional view taken along line A-A of FIG. 2;

FIG. 4 is an exploded perspective view of a protractor for teaching aid according to a second embodiment of the present invention;

FIG. 5 is an assembled view of FIG. 4;

FIG. 6 is a sectional view taken along line B-B of FIG. 5;

FIG. 7 is an exploded perspective view of a protractor for teaching aid according to a third embodiment of the present invention;

FIG. 8 is an assembled view of FIG. 7;

FIG. 9 is a sectional view taken along line C-C of FIG. 8;

FIG. 10 is an assembled front view of a protractor for teaching aid according to a fourth embodiment of the present invention;

FIG. 11 is an assembled front view of a protractor for teaching aid according to a fifth embodiment of the present invention with four indicating strips thereof located at a first position;

FIG. 12 is an assembled front view of the protractor for teaching aid according to the fifth embodiment of the present invention with four indicating strips thereof located at a second position;

FIG. 13 is an assembled front view of the protractor for teaching aid according to the fifth embodiment of the present invention with four indicating strips thereof located at a third position;

FIG. 14 is an assembled front view of the protractor for teaching aid according to the fifth embodiment of the present invention with four indicating strips thereof located at a fourth position;

FIG. 15 is an assembled front view of the protractor for teaching aid according to the fifth embodiment of the present invention with four indicating strips thereof located at a fifth position; and

FIG. 16 is an assembled front view of the protractor for teaching aid according to the fifth embodiment of the present invention with four indicating strips thereof located at a sixth position.

### DETAILED DESCRIPTION OF THE PREFERRED EMBODIMENTS

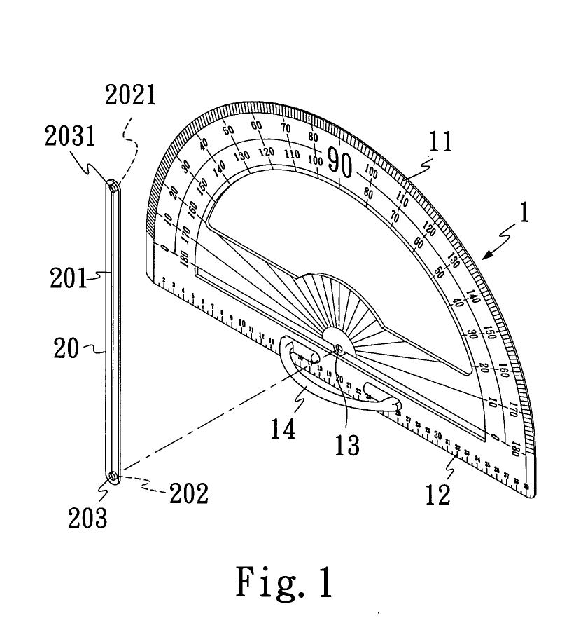

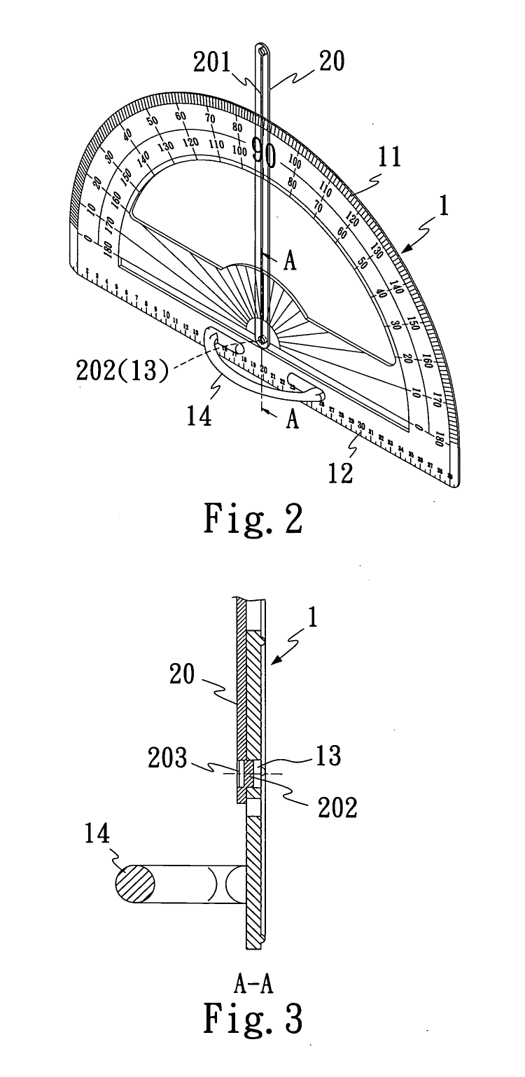

Please refer to FIGS. 1 and 2 that are exploded and assembled perspective views, respectively, of a protractor for teaching aid according to a first embodiment of the present invention, and to FIG. 3 that is a sectional view taken along line A-A of FIG. 2. As shown, the protractor for teaching aid according to the first embodiment of the present invention includes two major parts, namely, a generally semicircular disk 1 and a narrow and long indicating strip 20. The semicircular disk 1 is provided along a curved section thereof with angle marks 11, and long a straight edge thereof with length marks 12 to form a main body of the protractor. A locating hole 13 is formed at a center of the semicircular disk 1, and a handle 14 is provided to a front side of the semicircular disk 1 near the straight edge to enable convenient holding of the protractor. The indicating strip 20 is formed on one surface along a centerline thereof with a central marker 201. Two forward short bars 202, 2021 are formed at two ends on one side of the indicating strip 20, and two receiving holes 203, 2031 are correspondingly formed behind the two short bars 202, 2021, respectively. The indicating strip 20 may be connected to the semicircular disc 1 by engaging one of the short bars, for example, the short bar 202, with the locating hole 13 at the center of the protractor, so as to be turned about the locating hole 13.

To use the protractor for teaching aid, align a base line at an inner side of the straight edge of the semicircular disc 1 with one side of an angle to be measured, and align the central marker 201 on the indicating strip 20 with another side of the angle to be measured. And, the degrees of the angle being measured can be read from one of the angle marks 11 at where the central marker 201 crosses the curved section of the semicircular disk 1. Therefore, the protractor for teaching aid according to the present invention can be very easily and conveniently operated for use.

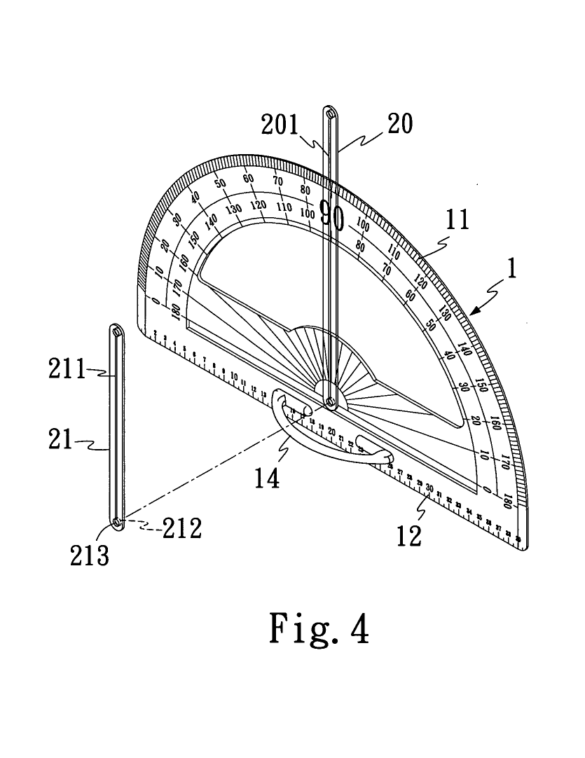

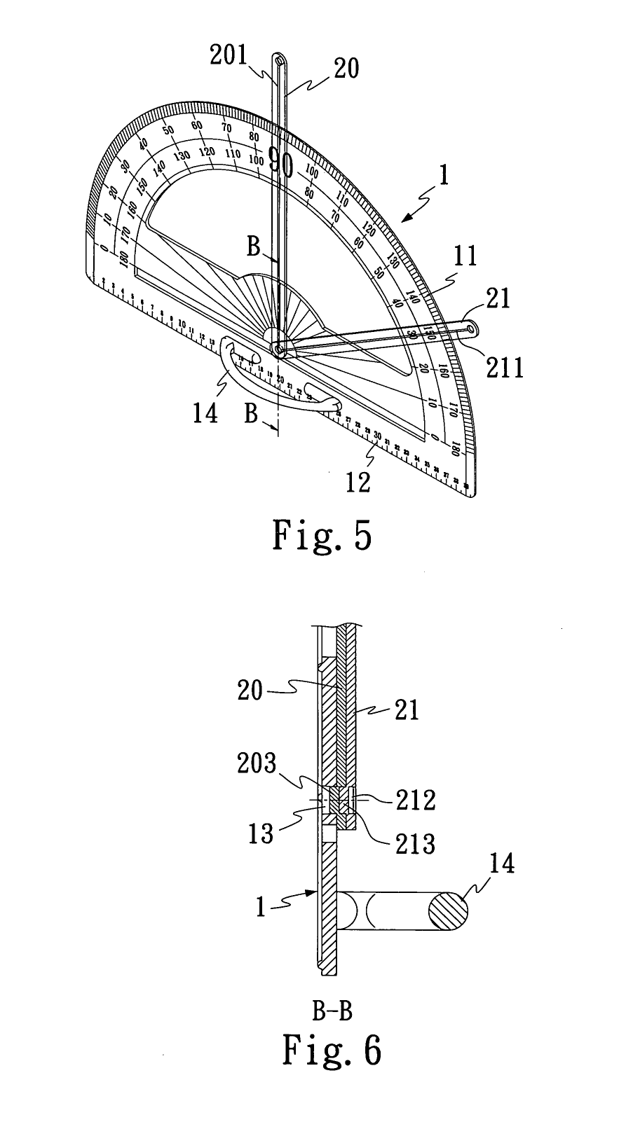

Please refer to FIGS. 4 and 5 that are exploded and assembled perspective views, respectively, of a protractor for teaching aid according to a second embodiment of the present invention, and to FIG. 6 that is a sectional view taken along line B-B of FIG. 5. As shown, the protractor for teaching aid according to the second embodiment of the present invention is generally structurally similar to the first embodiment, except that an additional indicating strip 21 is further provided. The second indicating strip 21 is structurally similar to the first indicating strip 20, and includes a central marker 211 provided on one surface thereof and a short bar 212 at each end on one side of the strip 21 adapted to engage with the receiving hole 203 on the first indicating strip 20, so that the two indicating strips 21, 20 may be turned about the locating hole 13 on the semicircular disk 1 for the two central markers 211, 201 to separately overlap one of two sides of an angle to be measured, or for the two central markers 211, 201 to cooperate the base line of the semicircular disk 1 to indicate the degrees of two angles.

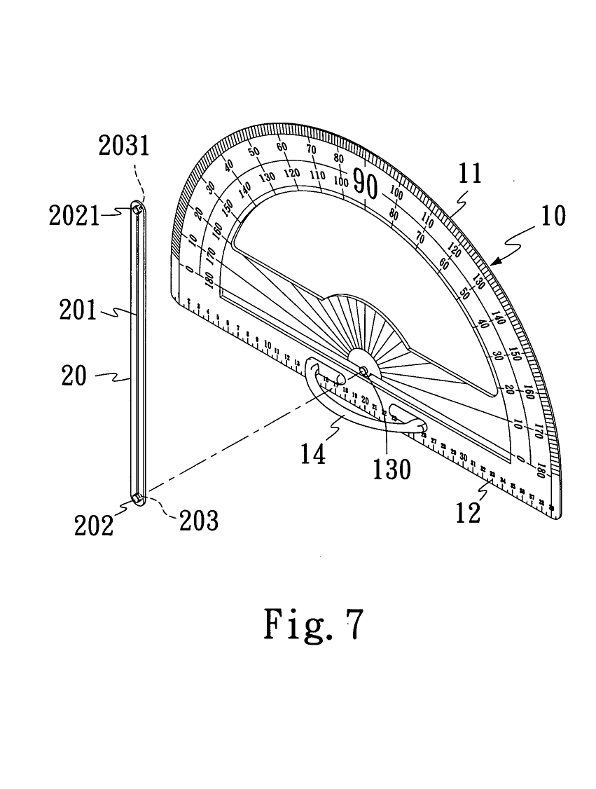

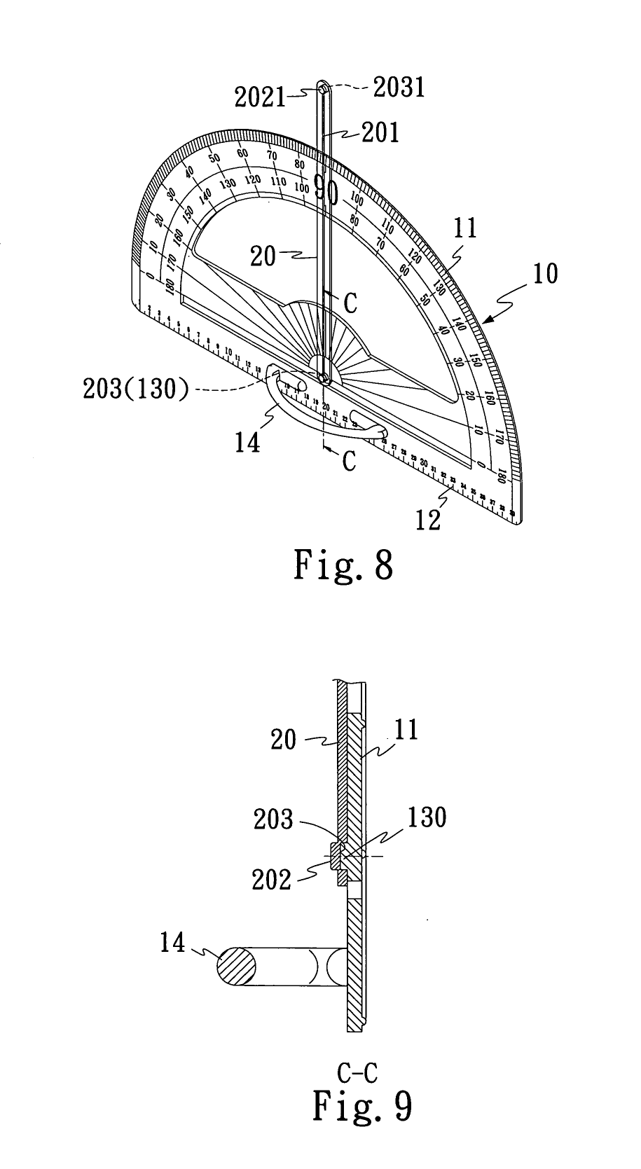

Please refer to FIGS. 7 and 8 that are exploded and assembled perspective views, respectively, of a protractor for teaching aid according to a third embodiment of the present invention, and to FIG. 9 that is a sectional view taken along line C-C of FIG. 8. As shown, the protractor for teaching aid according to the third embodiment of the present invention is structurally similar to the first embodiment, except for a semicircular disk 10 being provided at a center with a locating bar 130 adapted to engage with any of the receiving holes 203 at two ends of the indicating strip 20, so as to connect the indicating strip 20 to the semicircular disk 10.

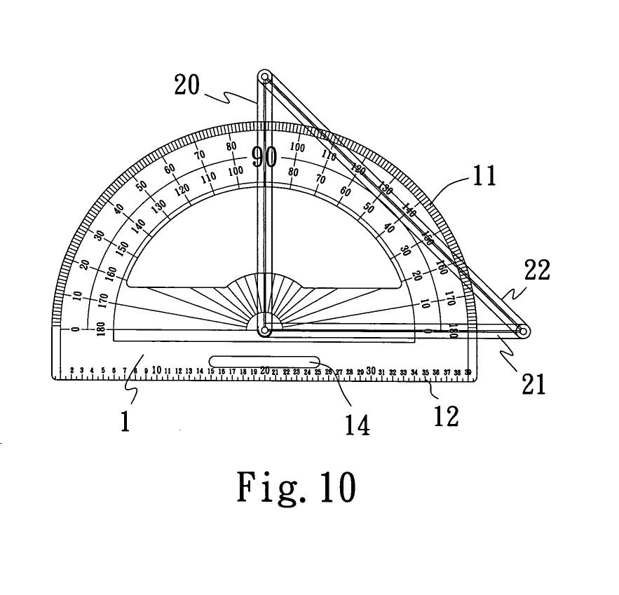

FIG. 10 is an assembled front view of a protractor for teaching aid according to a fourth embodiment of the present invention. As shown, the protractor for teaching aid according to the fourth embodiment of the present invention is structurally similar to the second embodiment, except that an additional indicating strip 22 is further provided. The third indicating strip 22 is structurally similar to the first and second indicating strips 20, 21, and has a short bar provided at each end on one side thereof, and a receiving hole correspondingly formed behind each of the short bar. To use the protractor of the fourth embodiment, align the second indicating strip 21 with the base line near the straight edge of the semicircular disk 1 (that is, the mark of 0 degree), and connect the short bars or the receiving holes at two ends of the third indicating strip 22 to distal ends of the first and the second indicating strip 20, 21. By connecting a third indicating strip 22 of a different length to the distal ends of the first and the second indicating strip 20, 21, the degrees of an angle contained between the first and the second indicating strip 20, 21 is changed accordingly. Therefore, the protractor of the fourth embodiment may be used as a teaching aid to teach the concept and measurement of an isosceles triangle.

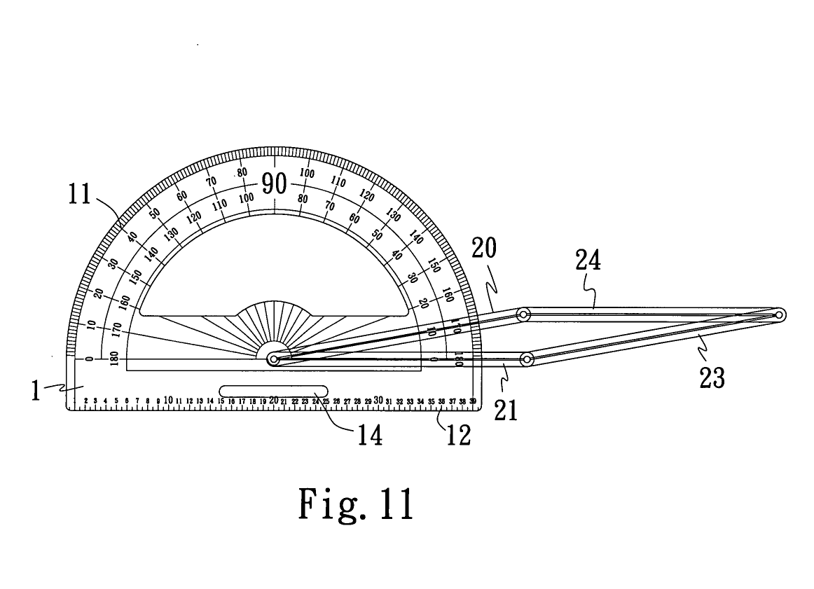

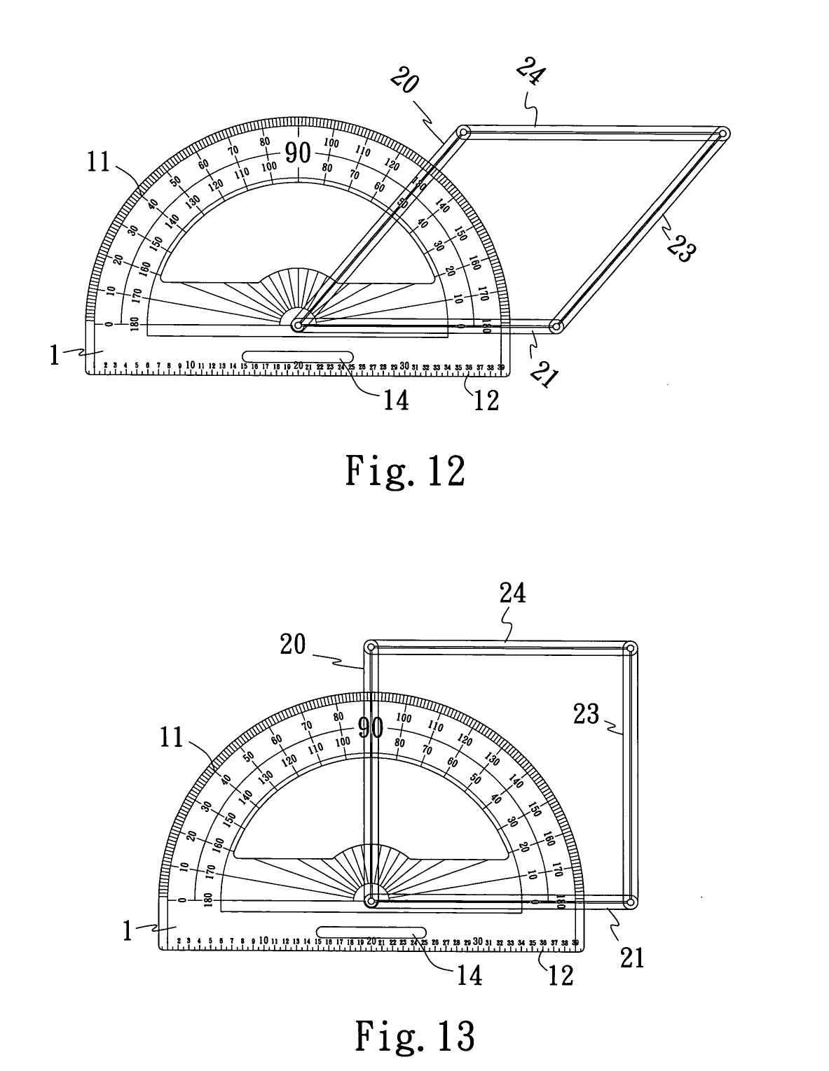

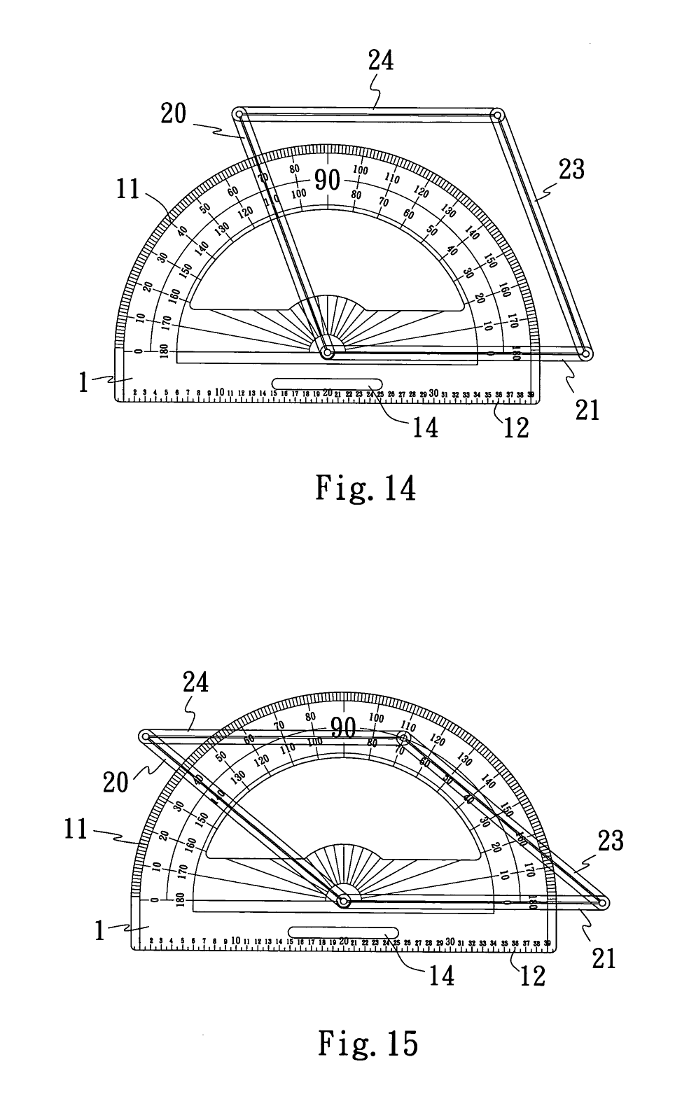

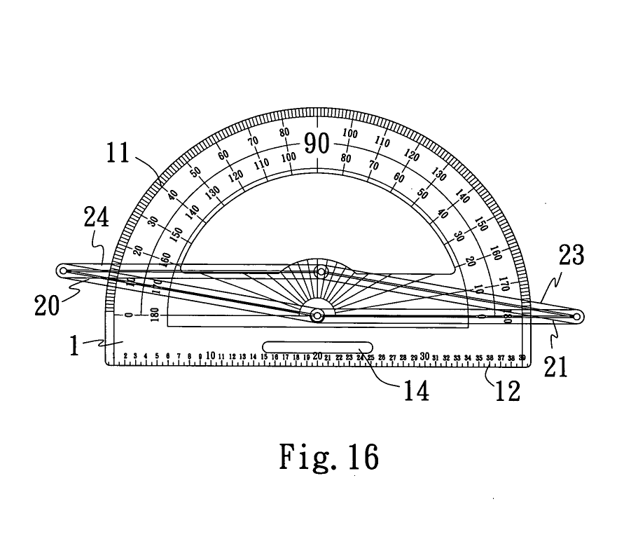

FIGS. 11 through 16 show a protractor for teaching aid according to a fifth embodiment of the present invention with four indicating strips thereof located at six different positions. As shown, the protractor of the fifth embodiment is structurally similar to the second embodiment, except for two additional indicating strips 23, 24, which have the same length. Each of the third and the fourth indicating strip 23, 24 has a short bar provided at each end on one side thereof, and a receiving hole correspondingly formed behind each of the short bar. To use the protractor of the fifth embodiment, connect the third and the fourth indicating strip 23, 24 to each other via the short bar and the receiving hole at one end thereof; connect the short bars or the receiving holes at the other end of the third and the fourth indicating strip 23, 24 to distal ends of the second and the first indicating strip 21, 20, respectively, so that the four indicating strips 20, 21, 23, 24 form a parallelogram; align the second indicating strip 21 with the base line near the straight edge of the semicircular disk 1; and turn the third indicating strip 23, which is located at an outer side of the second indicating strip 21, to different positions relative to the second indicating strip 21, 23. In FIG. 11, the third indicating strip 23 is turned to an almost horizontal position, so that an angle of ten degrees is contained between the first and the second indicating strip 20, 21, and the four indicating strips 20, 21, 23, and 24 together forms a flat rhombus. Then, the third indicating strip 23 is turned counterclockwise to accordingly increase the angle contained between the first and the second indicating strip 20, 21. In FIG. 12, an angle of 50 degrees is contained between the first and the second indicating strip 20, 21, and the four indicating strips 20, 21, 23, and 24 together forms a somewhat expanded rhombus. In FIG. 13, the third indicating strip 23 is further turned counterclockwise, so that a right angle of 90 degrees is contained between the first and the second indicating strip 20, 21 to form a square. When the third indicating strip 23 is kept turning counterclockwise, the angle contained between the first and the second indicating strip 20, 21 gradually increases. In FIG. 14, an angle of 110 degrees is contained between the first and the second indicating strip 20, 21, and the four indicating strips 20, 21, 23, and 24 together forms another somewhat expanded rhombus extended toward an opposite end of the protractor. FIGS. 15 and 16 show two gradually flattened rhombuses with an angle of 140 degrees and 170 degrees, respectively, contained between the first and the second indicating strip 20, 21.

With the semicircular disk 1 and the four indicating strips 20, 21, 23, and 24, the protractor for teaching aid according to the fifth embodiment of the present invention may be conveniently used to teach the variations in the shape and angle of a quadrilateral. Using the basic semicircular disk and the bar-and-hole connection manner provided by the present invention, multiple indicating strips may be pivotally connected to the locating hole 13 on the semicircular disk 1 to teach the concept of an angle. Alternatively, multiple indicating strips may pivotally connect to one another to form a polygon with a point thereof connected to the locating hole 13 on the semicircular disk 1 to teach the concept of different geometrical shapes. Therefore, the protractor for teaching aid according to the present invention has not only the one single function of measuring an angle, but also many other teaching functions.

What is claimed is:

1. A protractor for teaching aid, comprising:
a semicircular disk being provided along a curved section with angle marks, and along a straight edge with length marks to form a main body of a protractor, and a locating section being provided at a center of said semicircular disk;
at least one indicating strip being provided at two ends at one side thereof with a short bar each, and a receiving hole being correspondingly formed behind each of said short bars; said short bars and said receiving holes being adapted to engage with said locating section on said semicircular disk, so that said at least one indicating strip is pivotally turnably connected to said semicircular disk; and said indicating strip being provided on one surface along a centerline thereof with a central marker for accurately indicating any one of the angle marks on said semicircular disk when said indicating strip is turned about said locating section.

2. The protractor for teaching aid as claimed in claim 1, wherein said locating section on said semicircular disk is a locating hole, in which said short bar on said indicating strip is rotatably received.

3. The protractor for teaching aid as claimed in claim 1, wherein said locating section on said semicircular disk is a locating bar, to which said receiving hole on said indicating strip is rotatably mounted.

4. The protractor for teaching aid as claimed in claim 1, wherein a number of said indicating strips are connected end to end via said short bars and said receiving holes provided at two ends of said indicating strips, so as to form a polygon having a point located at said locating section on said semicircular disk.

5. The protractor for teaching aid as claimed in claim 1, wherein said semicircular disk is provided on one side near the center with a handle.
